(19) United States
(12) Patent Application Publication
(10) Pub. No.: US 2019/0142087 A1
(43) Pub. Date: May 16, 2019

(54) FRICTION ENHANCING ATHLETIC APPAREL

(71) Applicant: Taggert M. Kelly, Spring Lake, MI (US)

(72) Inventor: Taggert M. Kelly, Spring Lake, MI (US)

(21) Appl. No.: 15/812,239

(22) Filed: Nov. 14, 2017

(51) Int. Cl. A41D 20/00; C08L 1/02; C09D 127/06

(52) U.S. Cl. CPC A41D 20/00; C08K 5/11; C09D 127/06; C08L 1/02

(57) ABSTRACT

A wristband including: a body, wherein the body is generally tubular and adapted to be worn proximate the wrist of a user, and wherein the body includes an inner surface, an outer surface, a top side, a bottom side, a left side, a right side, a front end, and a rear end, and a friction enhancing member, wherein the friction enhancing member is associated with at least a portion of the outer surface of the body, and wherein the friction enhancing member aids in the catching and/or carrying of balls by a user.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A SEQUENCE LISTING

Not applicable.

### BACKGROUND OF THE INVENTION

### 1. Field of the Invention

The present invention relates in general to athletic apparel (e.g., wristbands, armbands, headbands, shirts, pants, gloves, etcetera) and, more particularly, to novel athletic apparel that comprise friction enhancing surfaces.

### 2. Background Art

Athletic apparel and associated accessories have been known in the art for years and are the subject of a plurality of patents and publications, including: U.S. Pat. No. 9,707,467 entitled “Athletic Glove,” U.S. Pat. No. 5,418,980 entitled “Friction Enhancing Wristband,” U.S. Pat. No. 5,146,628 entitled “Slip-Resistant Protective Glove and Method for Manufacturing Slip-Resistant Glove,” U.S. Pat. No. 4,881,276 entitled “Reinforced Cold Weather Sports Glove,” United States Patent Application Publication Number 2010/0122403 entitled “Garment Having Improved Contact Areas,” and United States Patent Application Publication Number 2010/0000005 entitled “Sports Compression Shirt”—all of which are hereby incorporated herein by reference in their entirety including all references cited therein.

U.S. Pat. No. 9,707,467 appears to disclose an athletic glove that includes a hand portion and a cuff portion. The hand portion includes a palm area and a plurality of digits. The cuff portion includes a resilient material operable to apply a biasing force to the wrist, thereby securing the glove to the hand without the use of a conventional mechanical fastener. The cuff portion extends beyond the wrist of the wearer, covering at least a portion of the lower forearm. The palm face of the glove further includes a grip enhancing surface disposed on one or more digits and/or the palm portion. The grip enhancing layer is positioned below the wrist and/or within the lower portion of the forearm to provide an extended contact surface to the wearer during gameplay.

U.S. Pat. No. 5,418,980 appears to disclose a wristband, particularly suitable for athletic use, that includes an elastic moisture absorbing sleeve having a high friction surface located over a major portion of the wristband whereby a ball, such as a football, gripped between the wristband and the wearer's body resists removal or dropping.

U.S. Pat. No. 5,146,628 appears to disclose a glove having patterned polyurethane coating adhered to the outer surface. The coating is about 1/32 inches high and about 1/16 inches wide to give the glove slip-resistant and gripping properties. The coating is formed from (a) a pre-mixed thixotropic component, a non-thixotropic component in a 2.5 to 1 ratio, and an accelerator, and (b) a cross-linking agent. The method of manufacturing the glove involves applying a mixture of (a) and (b) as a strip to the glove, allowing the strip of coating to wet the fibers and then curing at a low temperature for a relatively short period of time.

U.S. Pat. No. 4,881,276 appears to disclose a cold weather sports glove including at least one of the fingers or thumb having an area of low coefficient of friction and at least one opposing finger or thumb having an area of high coefficient of friction. The glove is formed with a layer of compressible neoprene foam rubber which forms the outer surface of the glove having a high coefficient of friction. Nylon pads are coupled to the outer surface of the foam rubber layer at the distal ends of preselected fingers or thumb. The area of low friction, formed by the nylon pads, permits the user to perform activities requiring a relative slipping motion between the user's finger or thumb and the device being used. The area of high friction, formed by the foam rubber layer, permits the user to grasp and release objects with more sensitivity and precision due to its compressibility. In fishing, preferably the thumb and index finger of the glove have areas of low coefficient of friction. In hunting, preferably the index finger of the glove is covered with an area of low coefficient of friction on both its palm and backhand sides. In archery, preferably the index finger, the middle finger and the pinky have areas of low coefficients of friction on their palm side to permit the bowstring to slide thereon when released. In a snowmobile mitt, preferably the index finger has an area of low coefficient of friction, while the thumb and the mitt portions are covered with areas of high coefficients of friction.

United States Patent Application Publication Number 2010/0122403 appears to disclose an athletic padding arrangement that includes a garment made of a fabric and a plurality of resilient bulge shaped gripping members disposed on the fabric. The gripping members provide at least one high friction area on the garment, each of the gripping members is uniform in composition. At least one protective pad is releasably positioned on the garment with an underside of the protective pad in contact with the at least one high friction area. The gripping members exert a frictional force on the underside of the protective pad that is greater than the frictional force exerted by the fabric on the protective pad. The garment may be, for example, a shirt or a pant comprised of a compression fabric with moisture wicking properties

United States Patent Application Publication Number 2010/0000005 appears to disclose a sports jersey/shirt suited for athletic participation, and particularly suitable for playing football, rugby, and the like where carrying a leather ball is involved. The shirt has several features that enhance the wearer's ability to firmly carry the ball with minimal slippage while improving the comfort of the shirt. The jersey includes a tactified surface on the outside surface of the sleeve where the ball contacts the arm as the player carries the ball in a tucked position. The surface is tacky to the touch to improve the connection between the arm, shirt, and ball, thereby promoting enhanced ball security.

While athletic apparel and associated accessories, as disclosed hereinabove, have been known in the art for years, issues associated with both friction enhancement and product longevity remain problematic and/or unresolved. As such, there remains a genuine demand for novel athletic apparel and associated assemblies that remedy the detriments and/or complications associated with conventional apparel.

These and other objects of the present invention will become apparent in light of the present specification, claims, and drawings.

### SUMMARY OF THE INVENTION

The present invention is directed to athletic apparel (e.g., wristbands, armbands, headbands, shirts, pants, gloves, etcetera) comprising, consisting essentially of, and/or consisting of: (a) a body, wherein the body is generally tubular and adapted to be worn proximate the wrist of a user, and wherein the body includes an inner surface, an outer surface, a top side, a bottom side, a left side, a right side, a front end, and a rear end; and (b) a friction enhancing member, wherein the friction enhancing member is associated with at least a portion of the outer surface of the body, and wherein the friction enhancing member aids in the catching and/or carrying of balls by a user.

In a preferred embodiment of the present invention, the body is fabricated from a flexible material, such as cotton and/or elastane. In this embodiment, the body may comprise a composite of approximately 80 percent by weight cotton and approximately 20 percent by weight elastane.

In another preferred embodiment of the present invention, the friction enhancing member comprises an elastomer coated onto at least a portion of the outer surface of the body.

In yet another preferred embodiment of the present invention, the friction enhancing member comprises a thermoplastic elastomer, such as a styrenic block copolymer, a thermoplastic olefin, an elastomeric alloy, a thermoplastic polyurethane, a thermoplastic copolyester, and/or a thermoplastic polyamide.

In another aspect of the invention, the elastomer preferably comprises a natural polyisoprene, a synthetic polyisoprene, a polybutadiene, a chloroprene rubber, a butyl rubber, a halogenated butyl rubber, a styrene-butadiene rubber, a nitrile rubber, a hydrogenated nitrile rubber, an ethylene propylene rubber, an ethylene propylene diene rubber, an epichlorohydrin rubber, a polyacrylic rubber, a silicone rubber, a fluorosilicone rubber, a fluoroelastomer, a perfluoroelastomer, a polyether block amide, a chlorosulfonated, ethylene-vinyl acetate, a resilin, an elastin, a polysulfide rubber, and/or an elastolefin.

In a preferred embodiment of the present invention, the friction enhancing member comprises a composite of polyvinyl chloride and a plasticizer. In this embodiment, the plasticizer preferably comprises a bio-based plasticizer, a dicarboxylic/tricarboxylic ester-based plasticizer, a trimellitate, an adipate, a sebacate, a maleate, an azelate, a benzoate, a terephthalates, 1,2-cyclohexane dicarboxylic acid diisononyl ester, an alkyl sulphonic acid phenyl ester, a sulfonamide, an organophosphate, a tricresyl phosphate, a tributyl phosphate, a glycol, a polyether, a triethylene glycol dihexanoate, a tetraethylene glycol diheptanoate, a polymeric plasticizer, and/or a polybutene.

In a preferred embodiment of the present invention, a bio-based plasticizer utilized, such as acetyl tributyl citrate, trioctyl citrate, acetyl trioctyl citrate, trihexyl citrate, acetyl trihexyl citrate, butyryl trihexyl citrate, and/or trimethyl citrate.

In another preferred embodiment of the present invention, the plasticizer comprises bis(2-ethylhexyl)adipate, dimethyl adipate, monomethyl adipate, dioctyl adipate, dibutyl sebacate, dibutyl maleate, and/or diisobutyl maleate.

In yet another preferred embodiment of the present invention, the body and/or the friction enhancing member is associated with an anti-microbial and/or anti-fungal agent.

In a preferred embodiment of the present invention, the friction enhancing member includes a plurality of chevron shaped apertures, offset chevron shaped apertures, and/or rows of substantially evenly spaced apart circular/oval apertures.

### BRIEF DESCRIPTION OF THE DRAWINGS

Certain embodiments of the present invention are illustrated by the accompanying figures. It will be understood that the figures are not necessarily to scale and that details not necessary for an understanding of the invention or that render other details difficult to perceive may be omitted. It will be further understood that the invention is not necessarily limited to the particular embodiments illustrated herein.

The invention will now be described with reference to the drawings wherein:

FIG. 1 of the drawings is an isometric view of a wristband manufactured in accordance with the present invention positioned on a user's arm proximate the wrist;

FIG. 2 of the drawings is an isometric view of the wristband of FIG. 1;

FIG. 3 of the drawings is a side view of the wristband of FIG. 1;

FIG. 4 of the drawings is a top plan view of the wristband of FIG. 1;

FIG. 5 of the drawings is a bottom plan view of the wristband of FIG. 1;

FIG. 6 of the drawings is a side elevational view of the wristband of FIG. 1;

FIG. 7 of the drawings is an isometric view of an alternative embodiment of a wristband manufactured in accordance with the present invention, showing offset chevron shaped apertures associated with the friction enhancing member;

FIG. 8 of the drawings is an isometric view of an alternative embodiment of a wristband manufactured in accordance with the present invention, showing chevron shaped apertures associated with the friction enhancing member; and

FIG. 9 of the drawings is an isometric view of an alternative embodiment of a wristband manufactured in accordance with the present invention, showing a plurality of rows of substantially evenly spaced apart circular/oval apertures.

### DETAILED DESCRIPTION OF THE INVENTION

While this invention is susceptible of embodiment in many different forms, there is disclosed and described herein in detail several specific embodiments with the understanding that the present disclosure is to be considered as an exemplification of the principles of the invention and is not intended to limit the invention to the embodiments illustrated.

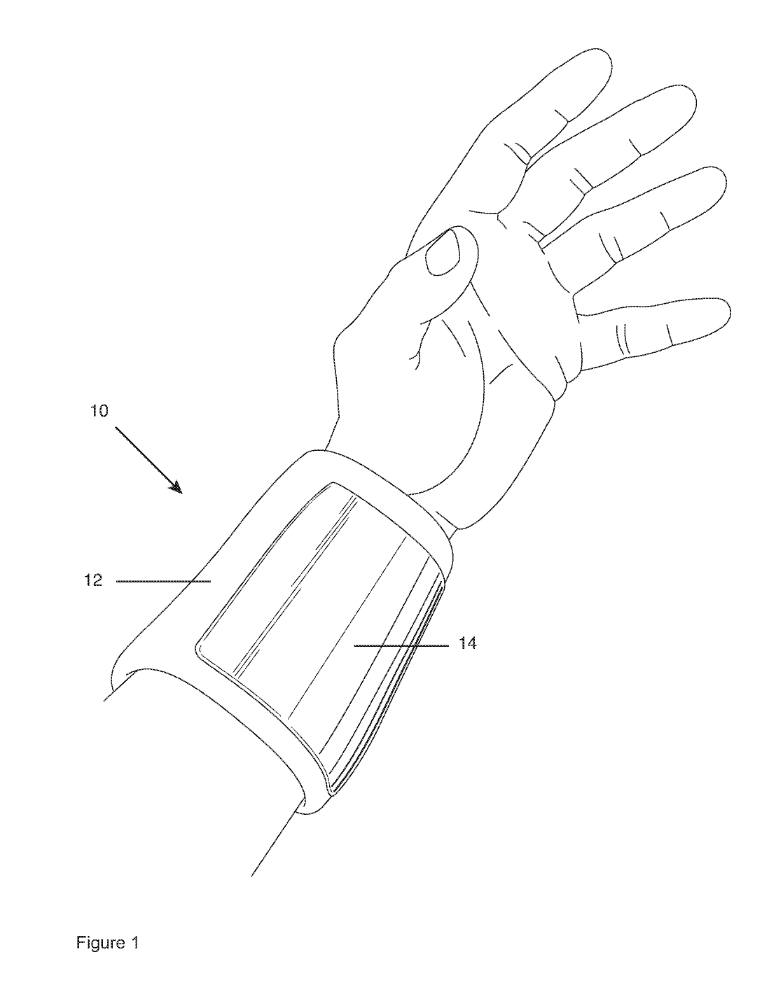

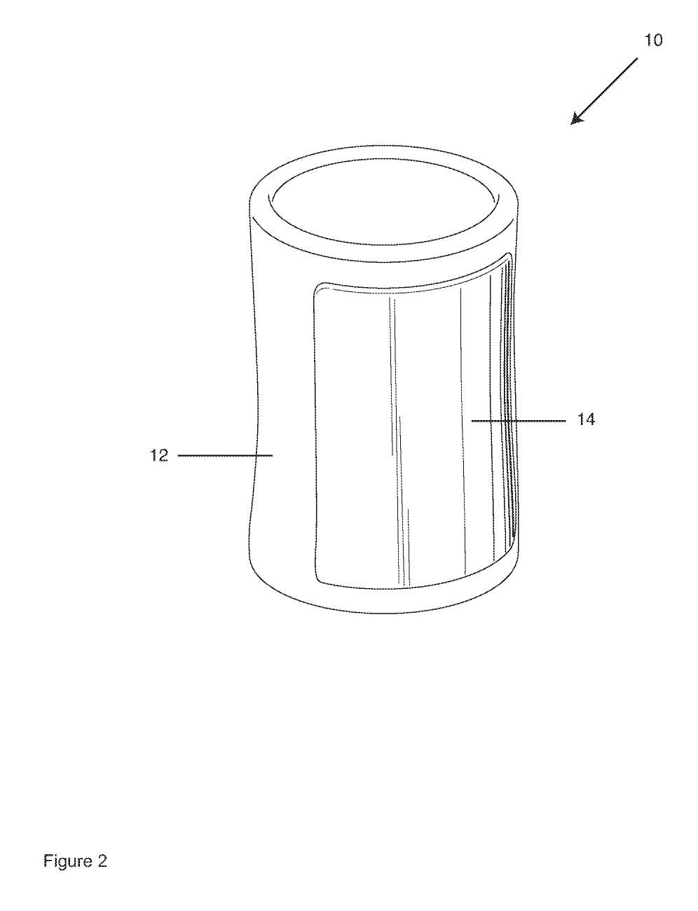

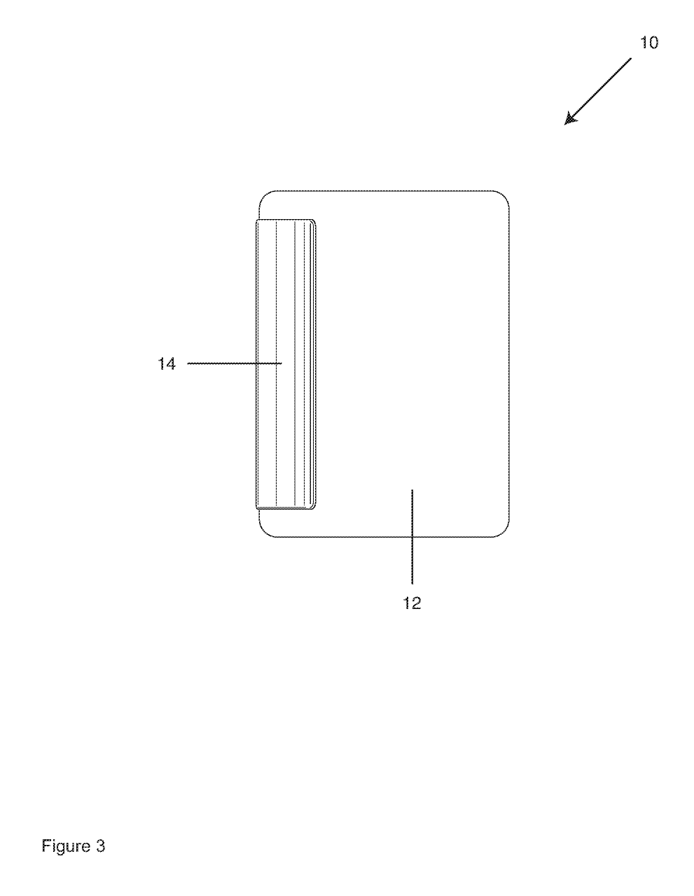

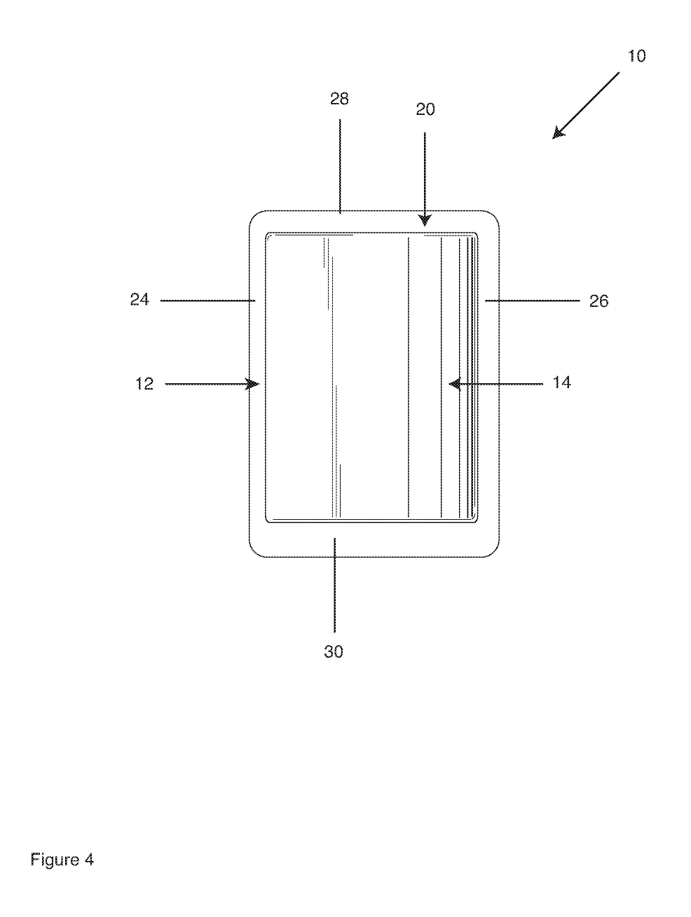

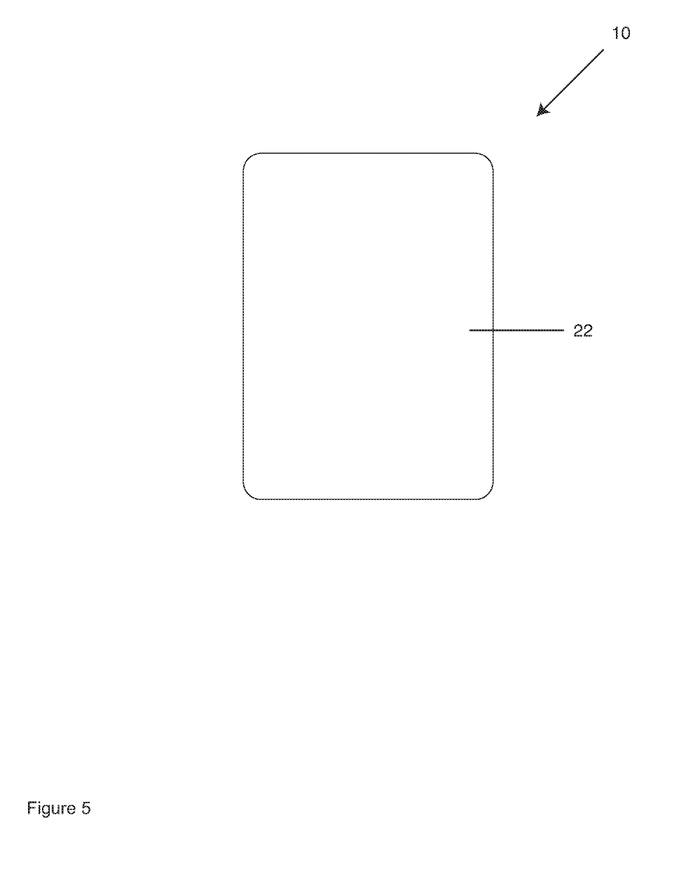

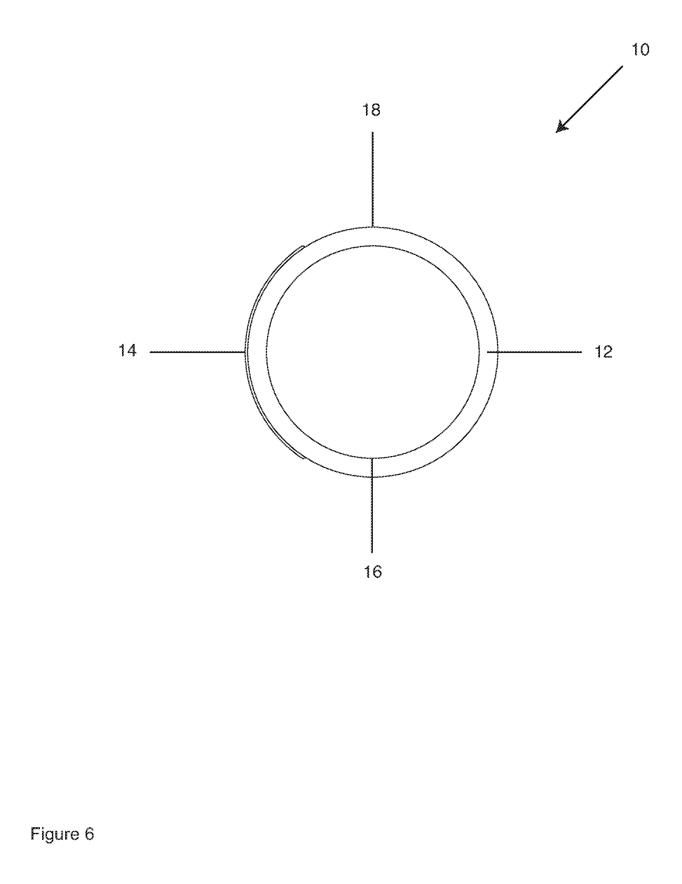

Referring now to the drawings and, more particularly, to FIGS. 1-6, wristband 10 is shown, which generally comprises body 12 and friction enhancing member 14.

Body 12 of wristband 10 is preferably generally tubular and adapted to be worn proximate the wrist of a user (See FIG. 1). Body 12 preferably includes inner surface 16, outer surface 18, top side 20, bottom side 22, left side 24, right side 26, front end 28, and rear end 30.

Body 12 of wristband 10 is preferably flexible, moisture absorbing, and fabricated from natural and/or synthetic fibers/materials—including, but not limited to cotton, wool, linen, silk, cashmere, hemp, jute, elastane, nylon, modacrylic, olefin, acrylic, polyester, rayon, vinyon, saran, spandex, vinalon, aramids (e.g., nomex, kevlar, twaron, etcetera), modal, dyneema/spectra, polybenzimidazole fiber, sulfar, lyocell, orlon, zylon, vectran, and/or derclon—just to name a few. In a preferred embodiment of the present invention, body 12 of wristband 10 is fabricated from a composite/hybrid of approximately 80 percent cotton and approximately 20 percent elastane.

It will be understood that while the present invention has been disclosed as comprising a wristband body, other athletic apparel are likewise contemplated for use in accordance with the present invention, including armbands, headbands, shirts, pants, gloves, etcetera.

Friction enhancing member 14 of wristband 10 is preferably associated with at least a portion of inner surface 16 (not shown) and/or outer surface 18 of body 12. When associated with outer surface 18, friction enhancing member 14 aids in the catching and/or carrying of balls (e.g., footballs, rugby balls, etcetera) by a user during normal use. When associated with inner surface 16, friction enhancing member 14 aids in the static placement of wristband 10, relative to a portion of the user's body.

In accordance with the present invention, friction enhancing member 14 is associated with inner surface 16 and/or outer surface 18 of body 12 via etch coating, dip coating, spin coating, brush coating and/or spray coating—including, but not limited to, cold spraying, thermal spraying, high velocity spraying (e.g., supersonic), low velocity spraying (e.g., subsonic), triboelectric discharge kinetic spraying and other similar processes.

In a preferred embodiment of the present invention, friction enhancing member 14 comprises an elastomer coated onto at least a portion of the outer surface of the body. In this embodiment, the elastomer may include a thermoplastic elastomer selected from the group consisting of a styrenic block copolymer, a thermoplastic olefin, an elastomeric alloy, a thermoplastic polyurethane, a thermoplastic copolyester, a thermoplastic polyamide, and combinations thereof.

Alternatively, the elastomer may be selected from the group consisting of a natural polyisoprene, a synthetic polyisoprene, a polybutadiene, a chloroprene rubber, a butyl rubber, a halogenated butyl rubber, a styrene-butadiene rubber, a nitrile rubber, a hydrogenated nitrile rubber, an ethylene propylene rubber, an ethylene propylene diene rubber, an epichlorohydrin rubber, a polyacrylic rubber, a silicone rubber, a fluorosilicone rubber, a fluoroelastomer, a perfluoroelastomer, a polyether block amide, a chlorosulfonated, ethylene-vinyl acetate, a resilin, an elastin, a polysulfide rubber, latex, an elastolefin, and combinations thereof.

In one preferred embodiment of the present invention, friction enhancing member 14 comprises a composite of polyvinyl chloride and a plasticizer. The plasticizer is preferably selected from the group consisting of a bio-based plasticizer, a dicarboxylic/tricarboxylic ester-based plasticizer, a trimellitate, an adipate, a sebacate, a maleate, an azelate, a benzoate, a terephthalates, 1,2-cyclohexane dicarboxylic acid diisononyl ester, an alkyl sulphonic acid phenyl ester, a sulfonamide, an organophosphate, a tricresyl phosphate, a tributyl phosphate, a glycol, a polyether, a triethylene glycol dihexanoate, a tetraethylene glycol diheptanoate, a polymeric plasticizer, a polybutene, and combinations thereof. Suitable examples of bio-based plasticizers include those selected from the group consisting of acetyl tributyl citrate, trioctyl citrate, acetyl trioctyl citrate, trihexyl citrate, acetyl trihexyl citrate, butyryl trihexyl citrate, trimethyl citrate, and combinations thereof. Examples of other plasticizers include those selected from the group consisting of bis(2-ethylhexyl)adipate, dimethyl adipate, monomethyl adipate, dioctyl adipate, and combinations thereof.

Dibutyl sebacate is a particularly preferred plasticizer when enhanced ultraviolet (UV) protection is desired to increase the longevity the elastomeric quality of friction enhancing member 14.

Friction enhancing member 14 may also be associated and/or impregnated with a UV absorbing material, such as substituted and unsubstituted benzotriazoles, substituted and unsubstituted triazines, benzophenone, and substituted and unsubstituted derivatives of benzophenones.

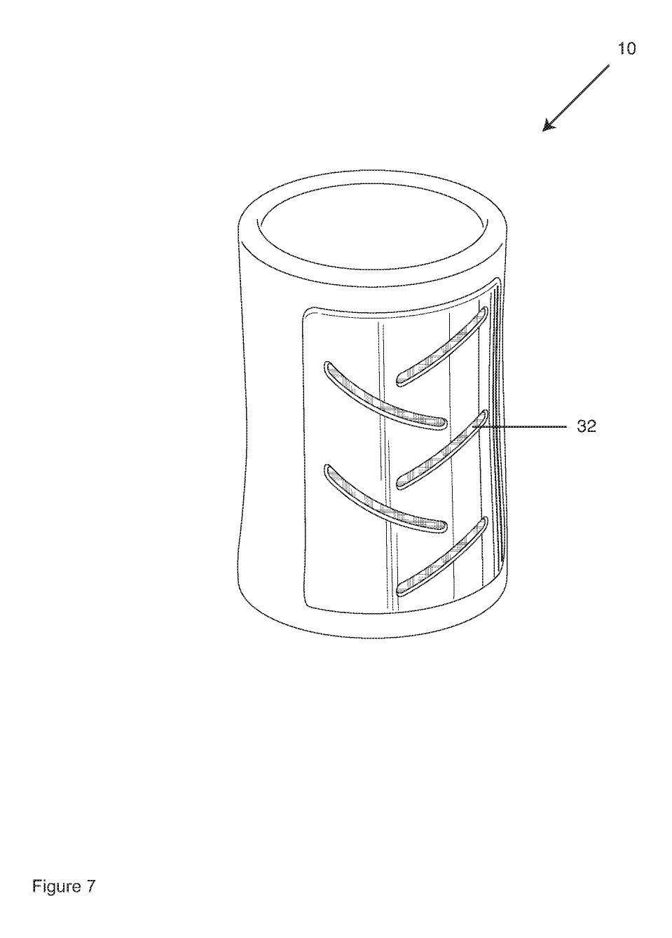

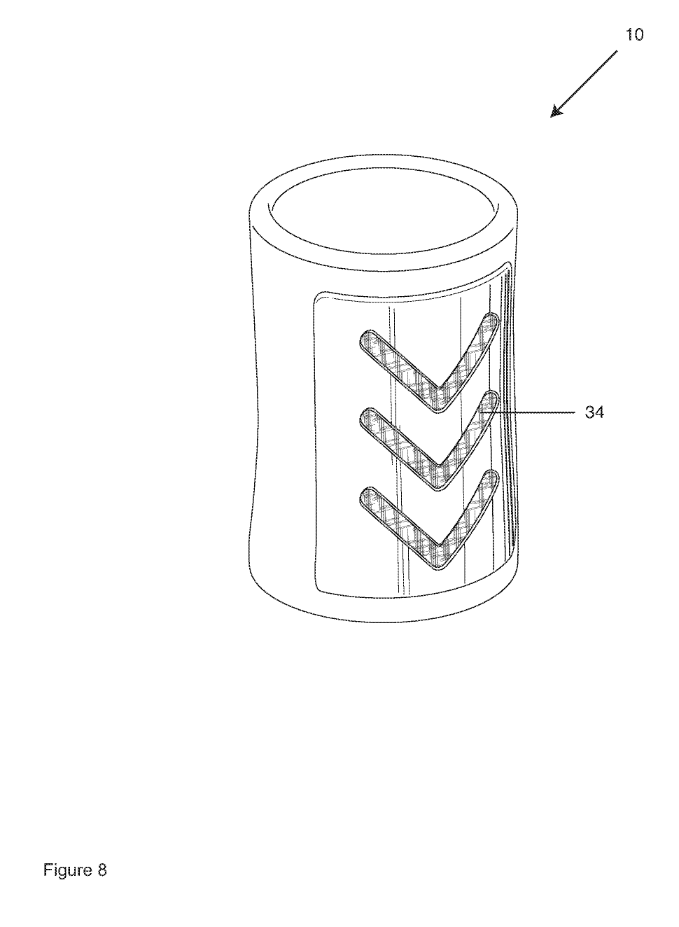

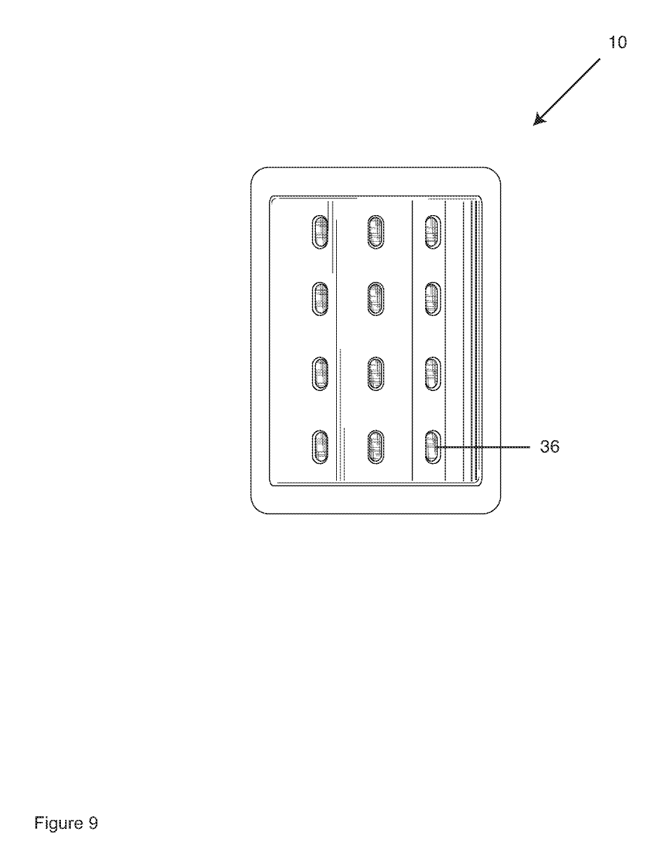

Referring now to FIGS. 7-9, friction enhancing member 14 preferably includes a plurality of offset chevron shaped apertures 32, chevron shaped apertures 34, and/or rows of substantially evenly spaced apart oval apertures 36. Apertures 32, 34, and 36 serve to increase both flexibility and longevity of wristband 10.

It will be understood that body 12 and/or friction enhancing member 14 of wristband 10 may be single or double sidedly dip or spray coated with an anti-microbial, anti-bacterial, anti-fungal and/or anti-viral agent, or alternatively one or both components may be impregnated with one or more of the aforementioned agents.

In accordance with the present invention, anti-microbial agents comprise chemical compositions that at least substantially inhibit microbial growth and/or kill bacteria, fungi and/or other microorganisms. A plurality of inorganic and/or organic chemical compositions which display anti-microbial activity are suitable for use with the present invention. Non-limiting examples of suitable organic substances that possess anti-microbial activity are carboxylic acids, alcohols and/or aldehydes, most of which appear to act by protein precipitation and/or by disruption of microbial cell membrane.

In one embodiment of the present invention, the anti-microbial activity of suitable inorganic substances is generally related to the ions, toxic to other microorganisms, into which they dissociate. The anti-microbial activity of various metal ions, for example, is often attributed to their affinity for protein material and the insolubility of the metal proteinate formed. Metal-containing salts are thus preferred among the inorganic substances that act as anti-microbial agents.

Metal inorganic salts, including simple salts of metal cations and inorganic anions like silver nitrate, are often soluble and dissociable and, hence, offer ready availability of potentially toxic ions.

Metal salts or complexes of organic moieties such as organic acids, on the other hand, are often less soluble and, therefore, are less dissociable than the soluble metal inorganic salts. Metal organic salts or complexes generally have a greater stability with respect to extraneous organic matter, and anions present in the environment of the living cell than metal inorganic salts, but have less toxic potential by virtue of their greater stability.

Silver ion is an example of a preferred metal ion which possesses anti-microbial activity. To the best of Applicant's knowledge silver ions react with a variety of anions as well as with chemical moieties of proteins. Precipitation of proteins, causing disruption of the microbial cell membrane and complexation with DNA, is likely the basis of the anti-microbial activity. Silver ions in high concentration will form insoluble silver chloride and thereby deplete chloride ions in vivo.

Anti-bacterials are antiseptics that have the proven ability to act against bacteria. Non-limiting examples of anti-bacterials suitable for use in accordance with the present invention include alcohols such as ethanol (20-99⁺%), 1-propanol (20-99⁺%) and 2-propanol/isopropanol (20-99⁺%) or mixtures of these alcohols. They are commonly referred to as “surgical alcohol”. Used to disinfect the skin before injections are given, often along with iodine (tincture of iodine) or some cationic surfactants (benzalkonium chloride 0.05-0.5%, chlorhexidine 0.2-4.0% or octenidine dihydrochloride 0.1-2.0%). Other common anti-bacterials include quaternary ammonium compounds known as Quats or QAC's, include the chemicals benzalkonium chloride (BAC), cetyl trimethylammonium bromide (CTMB), cetylpyridinium chloride (Cetrim, CPC) and benzethonium chloride (BZT). Benzalkonium chloride is used in some pre-operative skin disinfectants (conc. 0.05-0.5%) and antiseptic towels. The anti-microbial activity of Quats is inactivated by anionic surfactants, such as soaps. Related disinfectants include chlorhexidine and octenidine.

The foregoing description merely explains and illustrates the invention and the invention is not limited thereto except insofar as the appended claims are so limited, as those skilled in the art who have the disclosure before them will be able to make modifications without departing from the scope of the invention.

What is claimed and desired to be secured by Letters Patent of the United States is:

1. A wristband, comprising:
a body, wherein the body is generally tubular and adapted to be worn proximate the wrist of a user, and wherein the body includes an inner surface, an outer surface, a top side, a bottom side, a left side, a right side, a front end, and a rear end; and
a friction enhancing member, wherein the friction enhancing member is associated with at least a portion of the outer surface of the body, and wherein the friction enhancing member aids in the catching and/or carrying of balls by a user.

2. The wristband according to claim 1, wherein the body comprises a flexible material.

3. The wristband according to claim 2, wherein the body comprises a composite of cotton and elastane.

4. The wristband according to claim 3, wherein the body comprises a composite of approximately 80 percent cotton and approximately 20 percent elastane.

5. The wristband according to claim 4, wherein the friction enhancing member comprises an elastomer coated onto at least a portion of the outer surface of the body.

6. The wristband according to claim 5, wherein the friction enhancing member comprises a thermoplastic elastomer.

7. The wristband according to claim 6, wherein the thermoplastic elastomer is selected from the group consisting of a styrenic block copolymer, a thermoplastic olefin, an elastomeric alloy, a thermoplastic polyurethane, a thermoplastic copolyester, a thermoplastic polyamide, and combinations thereof.

8. The wristband according to claim 5, wherein the elastomer is selected from the group consisting of a natural polyisoprene, a synthetic polyisoprene, a polybutadiene, a chloroprene rubber, a butyl rubber, a halogenated butyl rubber, a styrene-butadiene rubber, a nitrile rubber, a hydrogenated nitrile rubber, an ethylene propylene rubber, an ethylene propylene diene rubber, an epichlorohydrin rubber, a polyacrylic rubber, a silicone rubber, a fluorosilicone rubber, a fluoroelastomer, a perfluoroelastomer, a polyether block amide, a chlorosulfonated, ethylene-vinyl acetate, a resilin, an elastin, a polysulfide rubber, an elastolefin, and combinations thereof.

9. The wristband according to claim 4, wherein the friction enhancing member comprises a composite of polyvinyl chloride and a plasticizer.

10. The wristband according to claim 9, wherein the plasticizer is selected from the group consisting of a bio-based plasticizer, a dicarboxylic/tricarboxylic ester-based plasticizer, a trimellitate, an adipate, a sebacate, a maleate, an azelate, a benzoate, a terephthalates, 1,2-cyclohexane dicarboxylic acid diisononyl ester, an alkyl sulphonic acid phenyl ester, a sulfonamide, an organophosphate, a tricresyl phosphate, a tributyl phosphate, a glycol, a polyether, a triethylene glycol dihexanoate, a tetraethylene glycol diheptanoate, a polymeric plasticizer, a polybutene, and combinations thereof.

11. The wristband according to claim 10, wherein the bio-based plasticizer is selected from the group consisting of acetyl tributyl citrate, trioctyl citrate, acetyl trioctyl citrate, trihexyl citrate, acetyl trihexyl citrate, butyryl trihexyl citrate, trimethyl citrate, and combinations thereof.

12. The wristband according to claim 9, wherein the plasticizer is selected from the group consisting of bis(2-ethylhexyl)adipate, dimethyl adipate, monomethyl adipate, dioctyl adipate, and combinations thereof.

13. The wristband according to claim 9, wherein the plasticizer is selected from the group consisting of dibutyl sebacate.

14. The wristband according to claim 9, wherein the plasticizer is selected from the group consisting of dibutyl maleate, diisobutyl maleate, and combinations thereof.

15. The wristband according to claim 1, wherein the friction enhancing member comprises latex.

16. The wristband according to claim 1, wherein at least one of the body and the friction enhancing member is associated with an anti-microbial agent.

17. The wristband according to claim 1, wherein at least one of the body and the friction enhancing member is associated with an anti-fungal agent.

18. The wristband according to claim 1, wherein the friction enhancing member includes a plurality of chevron shaped apertures.

19. The wristband according to claim 1, wherein the friction enhancing member includes a plurality of offset chevron shaped apertures.

20. The wristband according to claim 1, wherein the friction enhancing member includes three rows of substantially evenly spaced apart oval apertures.
